(19) United States
(12) Patent Application Publication
(10) Pub. No.: US 2006/0124082 A1
(43) Pub. Date: Jun. 15, 2006

(54) Diecast cylinder crankcase

(76) Inventors: Norbert Grunenberg, Weissach im Tal (DE); Guido Soell, Urbach (DE); Heinrich Wodarski, Koenigsfeld (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/521,938

(22) PCT Filed: Jul. 1, 2003
(86) PCT No.: PCT/EP03/06984

§ 371 Date: Dec. 12, 2005

(30) Foreign Application Priority Data
Jul. 23, 2002 (DE) 102 33 359.9

(51) Int. Cl. F02B 75/18; B22D 19/08; B23P 15/00

(52) U.S. Cl. 123/41.74; 164/98; 29/888.06

(57) ABSTRACT

The invention relates to a diecast cylinder crankcase into which a liner (4) consisting of a plurality of cylinder sleeves is cast. Said liner (4) is produced by sandcasting and is placed in the diecasting mould. The liner (4) comprises an at least partially closed water jacket (6) which can optionally comprise cooling channels (10) in the connecting section (12).

### BACKGROUND OF THE INVENTION

1. Field of the invention

The invention relates to a high-pressure die-cast cylinder crankcase in accordance with the preamble of claim 1 and to a process for producing a high-pressure die-cast crankcase as claimed in claim 5.

2. Related Art of the Invention

Modern engines increasingly have to make do with little installation space, while at the same time the thermal and mechanical loads on the engines are constantly rising. This requires complex cooling, and on account of the minimizing of the weight which is likewise desirable the wall thicknesses are also being constantly reduced and therefore less supporting material is available.

If is preferable for the cylinder crankcases of large-series engines to be produced using aluminum high-pressure diecasting for economic reasons. For this purpose, cylinder barrels are generally placed into the die and surrounded by casting. The distances between the cylinder barrels are in some cases reduced to less than 3 mm. The strength of the cylinder crankcase is reduced as a result of the narrowing of the webs.

Moreover, the spatial proximity in the region of the cylinder barrels makes it more difficult to form the water jacket, since in high-pressure die-casting there is only a limited freedom of design with regard to undercuts and cavities.

U.S. Pat. No. 4,446,906 describes a process for producing a cylinder crankcase using salt cores. This makes it possible to configure complex cooling passages, but for a component as large as the cylinder crankcase the process reliability has not proven suitable for large series production.

### SUMMARY OF THE INVENTION

The object of the invention is to provide a high-pressure die-cast cylinder crankcase and a process for producing it which has an improved strength and more effective cooling compared to the prior art with a low web width between the cylinder barrels.

The solution to the object consists in a high-pressure die-cast cylinder crankcase as claimed in claim 1 and in a process for producing a high-pressure die-cast cylinder crankcase as claimed in claim 5.

The high-pressure die-cast cylinder crankcase according to the invention as described in claim 1 is distinguished by the fact that it has a row of cylinder barrels cast onto one another. A row of cylinder barrels of this type is referred to in the specialist field as a liner, and consequently, this term will also be used in this context below. The liner is cast into the cylinder crankcase.

In this context, the term high-pressure die-casting is to be understood as meaning both high-pressure die-casting and squeeze casting, and the cylinder crankcase may in principle consist of all alloys which are suitable for these processes, in particular aluminum alloys but also magnesium alloys.

The liner is cast by sand casting or chill casting and therefore has the advantage that it is relatively simple to form cavities or undercuts. Therefore, the liner has an at least partially closed water jacket with various cooling passages. In particular, the water jacket is at least partially closed in the direction of a cylinder head side of the cylinder crankcase. At a mounting surface of the cylinder head, this leads to a larger sealing surface and to an improved sealing action between cylinder head and the cylinder crankcase.

A further advantage of the cylinder crankcase according to the invention consists in the fact that the webs between the cylinder barrels can be provided with cooling passages. When individual cylinder barrels are used, the distances between them are only between 3 mm and 4 mm. It is complex and expensive to mill or drill cooling passages into the web regions between cylinder barrels. Cooling passages in the web regions can be integrated as early as during use of the liners according to the invention.

In principle, the liner can consist of any castable material which satisfies the frictional and thermal requirements imposed on cylinder barrels. In the case of engines which are at particularly high pressures, for example diesel engines, the liners preferably consist of a gray cast iron material, whereas in gasoline engines, for weight reasons, a liner made from a hypereutectic aluminum-silicon alloy or ordinary aluminum casting alloys (standard alloys) is generally used.

In a further configuration, the liner is formed by a standard casting alloy based on aluminum rather than by a hypereutectic AlSi alloy. Chill or sand-cast components have a lower porosity than high-pressure die-cast components. The lower porosity facilitates the application of a layer which is able to withstand frictional loads, preferably a thermally sprayed layer, and improves the bonding of this layer. The sprayed layer serves as a wear-resistant layer and a cylinder running surface. One advantage of this variant consists in more favorable casting properties of the standard aluminum alloys.

A further component part of the invention is a process for producing a cylinder crankcase as claimed in claim 5, which comprises the following process steps:

A liner is produced using a casting process (sand or chill casting) which is known per se. The casting is carried out using a lost core which is used to form cooling passages. The liner has an at least partially closed water jacket.

The liner is then inserted into a high-pressure die-casting die. The bores of the individual cylinder barrels of the liner are fitted onto center sleeves in the high-pressure die-casting die and thereby fixed in place. Then, the high-pressure die-casting die is filled, likewise using a known high-pressure die-casting process. During the high-pressure die-casting, the liner is cast into the cylinder crankcase, with a bond between the two metal alloys (liner and cylinder crankcase) at least partially being produced.

Advantageous embodiments are described below on the basis of the figures and the process example.

### BRIEF DESCRIPTION OF THE DRAWINGS

In the drawing:

FIG. 1 shows a plan view of a cylinder crankcase with a liner,

FIG. 2 shows a cross section through a cylinder crankcase with liner in the region of a cylinder bore, and

FIG. 3 shows a longitudinal section through a cylinder crankcase with liner.

### DETAILED DESCRIPTION OF THE INVENTION

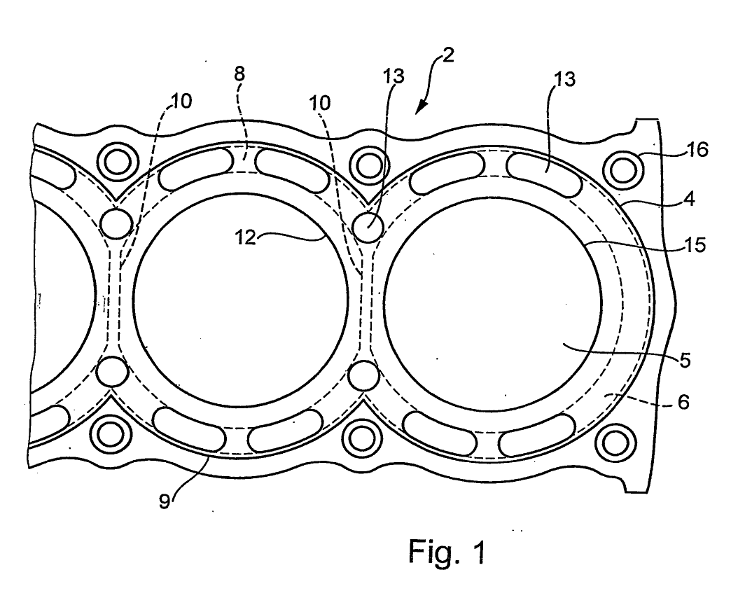

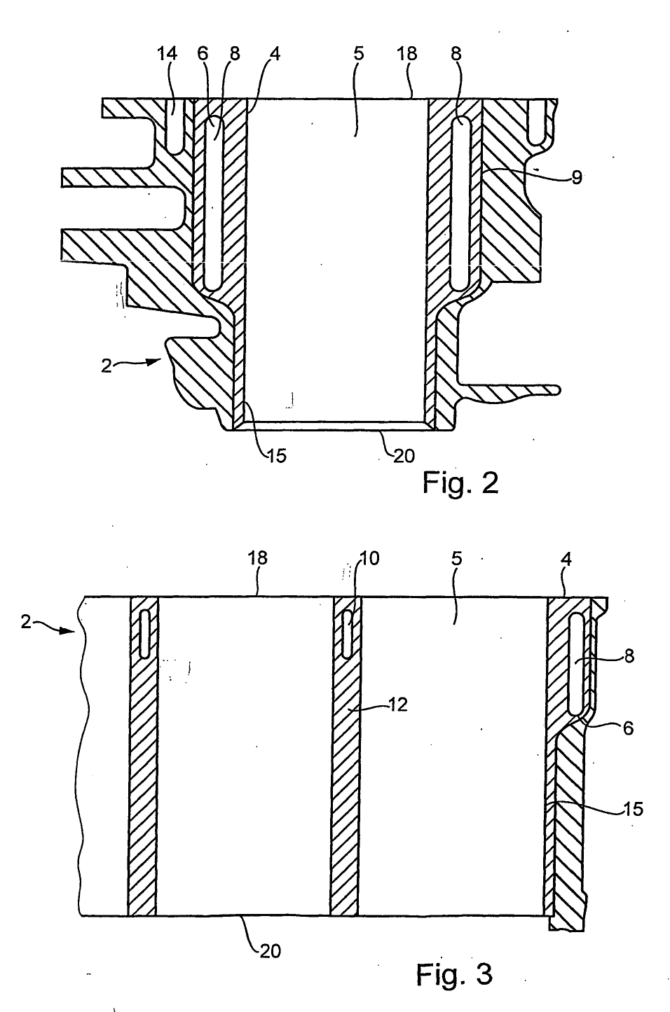

FIG. 1, starting from a cylinder head side 18 (cf. FIG. 2), shows a plan view of a cylinder crankcase 2 with a liner 4 which has been cast in according to the invention. The liner 4 comprises a plurality of cylinder barrels 5, which are in each case separated from one another by web regions 12 and are delimited by the cylinder running surfaces 15. The cylinder barrels 5 of the liner 4 have been cast onto one another in a single casting operation. A water jacket 6 has been cast into the outer region 9 of the liner 4. The water jacket 6 comprises a plurality of cooling passages 8, 10, generally connected to one another. In this context, a distinction is drawn between outer cooling passages 8, which run in the outer region 9 of the liner 4, and cooling passages 10 which run in the web region 12.

The water jacket 6 of the liner 4 is connected through transfer openings 13 to a water jacket 14 (FIG. 2) of the cylinder crankcase 2 and to a water jacket of a cylinder head (not shown). As is illustrated by dashed lines in FIG. 1, the outer cooling passages 8 are at least partially closed in the liner 4. Dashed lines are also used to illustrate the course of cooling passages 10 in the web region 12. Threaded bores 16 are used to secure the cylinder head.

The cross section through the cylinder crankcase 2 and the liner 4 illustrated in FIG. 2 shows the profile of the substantially closed outer cooling passages 8, and the figure also illustrates the water jacket 14 in the cylinder crankcase.

FIG. 3 illustrates a longitudinal section through a cylinder crankcase 2 with liner 4. The cooling passages 10 in the web region 12 are evident from this view. They are likewise substantially closed and, as illustrated by dashed lines in FIG. 1, are connected to the cooling passages 8.

The following example provides a more detailed explanation of the process for producing the cylinder crankcase 2 according to the invention. A chill mold with an integrated sand core is provided. The chill mold has the contour of the liner 4, while the sand core forms the subsequent water jacket 6. In the region of the web cooling passages 10, the core may have a minimum width of 1.5 mm.

A hypereutectic aluminum-silicon alloy, for example AlSil5, AlSil7or AlSi9, is cast into the chill mold by gravity die-casting or low-pressure die-casting. After cooling, the liner 4 is removed from the chill mold, the sand core is removed and the liner 4 is if appropriate deburred and/or machined. Moreover, the liner 4 may optionally be surface-treated with a view to improving the attachment to the cylinder crankcase 2. This may include mechanical roughening, such as sandblasting, chemical treatments or coatings.

Then, the liner 4 is placed on centre sleeves in a high-pressure die-casting die. The connection of the individual cylinder barrels 5 in the liner 4 allows very accurate centering of the barrels 5, which leads to a more accurate spacing of the bores in the cylinder crankcase 2. The cylinder crankcase 2 is then cast using the high-pressure die-casting process employing a suitable aluminum alloy, e.g. an AlSi9Cu3. During the high-pressure die-casting, at least in regions a chemical bond is formed between the alloy of the liner and of the cylinder crankcase at the boundary surfaces thereof.

If appropriate, the liner 4 may be designed so as to be closed toward an oil sump side 20. This can be effected by a base (not shown) which is cast on as early as during production of the liner 4. This measure prevents the aluminum melt from penetrating (splashing) between cylinder running surfaces 15 and center sleeve during the high-pressure die-casting. The remachining outlay is significantly reduced as a result. Only the base which closes off the cylinder barrel 5 has to be remachined.

A further advantage of the cylinder crankcase 2 according to the invention is that the increased surface area of the liner 4 compared to that of individual cylinder barrels leads to better linking between the cylinder crankcase 2 and the cast-in part (liner 4) . As a result, in turn the heat transfer between the cylinder running surfaces 15, which are subject to high thermal loads, and the cylinder crankcase 2 is improved.

Furthermore, the integrated design of the liner 4 prevents slight sinking of the cylinder barrels when the engine is operating (settling) which may occur on occasion. This measure also prevents cooling water from being able to enter the oil circuit, which occurs under certain circumstances if a gap occurs between the barrel and the casting surrounding it (cylinder crankcase) in the case of individual barrels.

In a further embodiment of the invention, the liner is cast by chill casting using an AlSi7Mg alloy. After machining, a layer is applied to inner surfaces of the cylinder barrels by plasma spraying. This layer of a hypereutectic AlSi alloy serves as a cylinder running surface after final machining (precision turning, honing).

In principle, the layer can be applied by all conventional coating processes. Thermally sprayed layers, for example those formed by plasma spraying, wire arc spraying or flame spraying, have proven suitable. The layer material used may likewise in principle be any wear-resistant material which in terms of its frictional properties is matched to the friction partner, a piston ring (and piston skirt).

1. A high-pressure die-cast cylinder crankcase, wherein
at least one continuous row (4) of at least two cylinder barrels (5) is cast into the cylinder crankcase (2),
the row of cylinder barrels (4) comprises a sand casting or chill casting,
the row of cylinder barrels (4) has at least one water jacket (6), and
the water jacket is at least partially closed with respect to a side (18) of the cylinder crankcase (2) which faces a cylinder head.

2. A high-pressure die-cast cylinder crankcase, wherein
at least one continuous row (4) of at least two cylinder barrels (5) is cast into the cylinder crankcase (2),
the row of cylinder barrels (4) comprises a sand casting or chill casting,
the row of cylinder barrels (4) has at least one water jacket (6), and
the at least one cooling passage (10) of the water jacket (6) runs through the web region (12) between the cylinder barrels (5).

3. The high-pressure die-cast cylinder crankcase as claimed in claim 1, wherein the row of cylinder barrels (4) consists of an iron-based cast material.

4. The high-pressure die-cast cylinder crankcase as claimed in claim 1, wherein the row of cylinder barrels (4) consists of a hypereutectic aluminum-silicon alloy.

5. The high-pressure die-cast cylinder crankcase as claimed in claim 1, wherein the row of cylinder barrels (4) consists of a standard aluminum casting alloy, and a cylinder running surface is coated with a layer that is able to withstand frictional loads.

6. The high-pressure die-cast cylinder crankcase as claimed in claim 5, characterized in that wherein the layer is a thermally sprayed layer.

7. A process for producing the high-pressure die-cast cylinder crankcase wherein
at least one continuous row (4) of at least two cylinder barrels (5) is cast into the cylinder crankcase (2),
the row of cylinder barrels (4) comprises a sand casting or chill casting,
the row of cylinder barrels (4) has at least one water jacket (6), and
the water jacket is at least partially closed with respect to a side (18) of the cylinder crankcase (2) which faces a cylinder head;
said process comprising the following steps:
casting a row of cylinder barrels (4) using a lost core so as to form an at least partially closed water jacket (6),
placing the row of cylinder barrels (4) into a high-pressure die-casting die of a cylinder crankcase (2), and
high-pressure die-casting the cylinder crankcase (2) and at the same time casting in the row of cylinder barrels (4).

8. The high-pressure die-cast cylinder crankcase as claimed in claim 2, wherein the row of cylinder barrels (4) consists of an iron-based cast material.

9. The high-pressure die-cast cylinder crankcase as claimed in claim 2, wherein the row of cylinder barrels (4) consists of a hypereutectic aluminum-silicon alloy.

10. The high-pressure die-cast cylinder crankcase as claimed in claim 2, wherein the row of cylinder barrels (4) consists of a standard aluminum casting alloy, and a cylinder running surface is coated with a layer that is able to withstand frictional loads.

11. The high-pressure die-cast cylinder crankcase as claimed in claim 10, wherein the layer is a thermally sprayed layer.

12. A process for producing the high-pressure die-cast cylinder crankcase wherein
at least one continuous row (4) of at least two cylinder barrels (5) is cast into the cylinder crankcase (2),
the row of cylinder barrels (4) comprises a sand casting or chill casting,
the row of cylinder barrels (4) has at least one water jacket (6), and
the at least one cooling passage (10) of the water jacket (6) runs through the web region (12) between the cylinder barrels (5); said process comprising the following steps:
casting a row of cylinder barrels (4) using a lost core so as to form an at least partially closed water jacket (6),
placing the row of cylinder barrels (4) into a high-pressure die-casting die of a cylinder crankcase (2), and
high-pressure die-casting the cylinder crankcase (2) and at the same time casting in the row of cylinder barrels (4).
